(19) United States
(12) Patent Application Publication
(10) Pub. No.: US 2015/0096529 A1
(43) Pub. Date: Apr. 9, 2015

(54) COLD START-UP SYSTEM OF AN INTERNAL COMBUSTION ENGINE AND INTERNAL COMBUSTION ENGINE

(71) Applicant: Continental Brasil Indústria Automotiva Ltda., Guarulhos SP (BR)

(72) Inventors: Ivan Sanches Provase, Sao Paulo (BR); Marcos Oliveira, Jardim dom Vieira (BR); Alexandre Rezende, Sao Paulo (BR)

(21) Appl. No.: 14/381,456

(22) PCT Filed: Feb. 26, 2013
(86) PCT No.: PCT/BR2013/000053

§ 371 Date: Aug. 27, 2014

(30) Foreign Application Priority Data
Feb. 29, 2012 (BR) BR102012004566.4

(51) Int. Cl. F02N 19/04; F02D 19/10; F02M 43/00

(52) U.S. Cl. CPC F02N 19/04; F02M 43/00; F02D 19/105
USPC 123/294

(57) ABSTRACT

The present invention relates to a cold start-up system of an internal combustion engine for an engine burning gasoline, ethanol or a mixture of fuels, composed or not of a preponderant fraction of ethanol, which comprises at least one strategy of pre-injection of fuel through at least one injection nozzle, before activation of the starter motor, or during activation, in an asynchronous manner.

The present invention relates to a cold start-up system of an internal combustion engine for a direct injection engine or not, which burns gasoline, ethanol or a mixture of fuels, composed or not of a preponderant fraction of ethanol and which ensures the cold start under any ambient temperature conditions without the use of a more volatile fuel such as gasoline the start in situations where ethanol is used.

The present invention also relates to a start-up system of an internal combustion engine which, depending on the type of fuel used and the ambient temperature, improves and optimizes the amount of fuel used and/or the starting time for the engine to start.

The present invention also relates to an internal combustion engine that incorporates such a cold start-up system.

### DESCRIPTION OF THE RELATED ART

Historically, gasoline has always been the fuel used by the vast majority of internal combustion Otto-cycle engines, due to its highly desirable physicochemical properties such as calorific value, resistance to detonation and vaporization coefficient even at low temperatures, like those found in much of the northern hemisphere in winter, allowing cold start of the engine with reasonable ease even in the toughest conditions.

It happens that the shortage and rising of oil prices in the early 1970s made Brazil choose to vary its energy matrix and start producing ethanol on a large scale to move automobiles.

In the 80s, the cars driven by ethanol have come to dominate the Brazilian market and the use of ethanol as fuel has gained further strength from 2003, with the launch of multi-fuel vehicles, better known as flex-fuel vehicles, which burn ethanol, gasoline or a mixture of these fuels in any proportion, maintaining satisfactory levels of performance, drivability and emission of pollutants.

Nowadays, flex-fuel vehicles largely dominate the Brazilian market and are also available in some other countries, like the United States. However, although they are far more evolved if compared to the first ethanol powered cars available in the 80s, the flex-fuel vehicles suffer from the same drawback, which is the need for a specific gasoline tank, positioned close to the engine in the vast majority of cases, to ensure cold starting at low ambient temperature conditions and the engine operation in the initial instants of operation (called cold phase).

The need of using gasoline during cold start is due to the coefficient of vaporization of ethanol, considerably lower than that presented by gasoline, combined with the high flash point that ethanol has under low ambient temperature.

An example of technology regarding the use of gas during cold start of engines powered by ethanol may be found in granted patent BR9905212-1, which refers to a cold start system in which an electric pump, via a duct, feeds a gas injection nozzle, which can be located in the body of the butterfly valve or in the intake manifold, thereby injecting a certain amount of gasoline into the air/ethanol mixture.

Another relevant document is patent BRPI0904130-3, which refers to a cold start system for internal combustion engines, and more specifically, to a cold start system through quantified fuel spray particularly designed for use in a internal combustion engine driven by ethanol and/or flex type.

This cold starting system comprises a reservoir for gas, a fuel pump, a first fuel line connecting said pump to a solenoid valve and a second fuel line connecting the outlet of said solenoid valve to a plurality of atomizing nozzles in a number corresponding to the engine cylinders.

The first fuel line, the solenoid valve, the second fuel line and the atomizing nozzles comprise a high pressure system with which whirled and atomized fuel is discharged from the atomizing nozzles providing a high-efficiency atomization.

However, in all systems, there is a difficulty of precise dosage of the volume of gas injected, leading to a high emission of pollutants at the beginning of the engine operation, which tends to be increasingly opposed to. Moreover, to the user/owner of the vehicle, it is always inconvenient to have to monitor the level of gasoline in the small tank, and forgetfulness may mean that the vehicle will not work the next morning. Another drawback of using a small gas tank is its low power consumption, which can lead to deterioration and consequent damage to the fuel supply system.

Finally, there are those who claim that the small gas tank may rupture or leak and cause a fire when the vehicle suffers a head-on collision or rollover.

Aiming to overcome the drawbacks of using a small gas tank, several technologies of ethanol preheat for cold start were developed and improved, but their use is limited by some technical difficulties which are hard to overcome, which limits its market penetration, to the point that the large majority of vehicles sold today still use the small gas tank as a cold start system.

A first example of such a technology is disclosed by patent document BRPI0403039-7, whereby the cold start-up system has a fuel line provided with a fuel inlet and, on the opposite side, a bypass that connects to a flow control device or cold start auxiliary flow.

Under cold start conditions, the ethanol existing in the main gallery reaches the controlled flow bypass and then enters a fuel heating device. After heating, the fuel is driven to the engine through the duct system and distributed uniformly to its cylinders.

The drive device heating fuel can be done under the management of the electronic control unit, by the signal from a switch installed in the vehicle door, or another type of signal, which tells the electronic control unit that the vehicle will be started up and, thus, the process for fuel controlled heating begins.

Another example of this type of technology can be found in patent document BRPI0504047-7, which discloses a cold start-up auxiliary system for ethanol and flex engines with air-inlet and ethanol warm up. The cold starting system comprises the use of resistors positioned in the entrance of the injectors, a resistor inside each injector or a resistor for every nozzle holder pipe, and these three possibilities can be used simultaneously, combined two by two or separately, depending on the need for warmed up ethanol flow and the energy consumption.

The system further comprises the use of sets of resistors positioned in the upper part of the intake manifold, in the bottom part of the manifold, in the throttle body, in the headstock intake ducts and sets of resistors in the secondary air inlet pipe near the exhaust manifold.

Optionally, there may be further provided a set of resistors inside the housing of the air filter or in the pipe for sending air to the throttle body and the secondary pipe, and a set of secondary resistors in the pipe for sending air to the throttle body.

The resistors are used in a combined or isolated manner, commanded by the injection and fuel module system and, additionally, one may foresee one or two auxiliary injectors (supplementary) in the intake manifold with the same ethanol heating system, that is, at the entrance of the injectors, inside the injectors or inside of the nozzle holder pipe.

It is evident the complexity of this type of system, of a high cost of installation and which requires high processing capabilities to decide which resistors to trigger, together with the consumption of electrical current from the battery to make it functional, which becomes a problem to the extent that the battery gets old, such that the efficiency of the system tends to decline with the aging of the vehicle.

The analysis of the existing solutions, nowadays, makes it clear that it had not been developed until now, a cold start up system for an Otto-cycle engine which burns, gasoline, ethanol or a mixture of fuels, composed or not of a preponderant fraction of ethanol, which shows technical simplicity, low consumption of electrical current from the battery, high reliability, and which does not require gasoline to ensure starting up and operation of the engine in the cold phase, especially below 16° C.

### OBJECTS OF THE INVENTION

The present invention relates to a cold start-up system for an Otto-cycle engine, either direct injection or not, which burns gasoline, ethanol or a mixture of fuels, composed or not of a preponderant fraction of ethanol and which ensures starting up and operation of the engine in the cold phase (low ambient temperature), even if they are negative temperatures, below the freezing point of water.

It is also an object of the present invention to provide a cold start system which does not require injection of gasoline to ensure start up and running of the engine during the cold phase.

The present invention also relates to a cold starting system which ensures start-up and running of the engine in the cold phase, with previous warming up, or not, of the fuel, the fuel being gasoline, ethanol or a mixture of fuels, composed or not of a preponderant fraction of ethanol.

In addition, the present invention relates to a cold start-up system which ensures start-up and running of the engine in the cold phase, from synchronous or asynchronous fuel injection, before or during start up time.

The present invention also relates to a start-up system of an internal combustion engine which depending on the type of fuel used and the ambient temperature improves and optimizes the amount of fuel used or even the time during start-up and after start-up for the engine to start running properly.

Finally, the present invention relates to an internal combustion engine, especially an engine that operates according to the Otto cycle, either direct or indirect injection, provided with the cold start-up system presently claimed.

### BRIEF DESCRIPTION OF THE INVENTION

The objectives of the present invention are achieved by a cold start-up system of an internal combustion engine for an engine burning gasoline, ethanol or a mixture of fuels, composed or not of a preponderant fraction of ethanol, which comprises at least one strategy of pre-injection of fuel through at least one injection nozzle or similar device before or during actuation of the starter motor, in a synchronous or asynchronous manner.

Additionally, the objects of the present invention are achieved by an internal combustion engine, comprising a cold start-up system presently claimed.

### BRIEF DESCRIPTION OF THE DRAWINGS

The present invention will be further described in more details based on one example of execution represented in the drawings. The figures show:

FIG. 1 is a diagram showing the curve of vaporization of ethanol.

FIG. 2 shows a curve of vapor pressure of ethanol at ambient temperature.

FIG. 3 is a graph illustrating the Δt control between activation of the system and the pre-injection.

FIG. 4 is a graph obtained after the start up of an engine driven by ethanol without use of the pre-injection strategy at a temperature of 0° C., failing at start-up.

FIG. 4 is a graph obtained after the start-up of an engine driven by ethanol with use of the pre-injection strategy at an ambient temperature of −5.25° C., successfully.

### DETAILED DESCRIPTION OF THE DRAWINGS

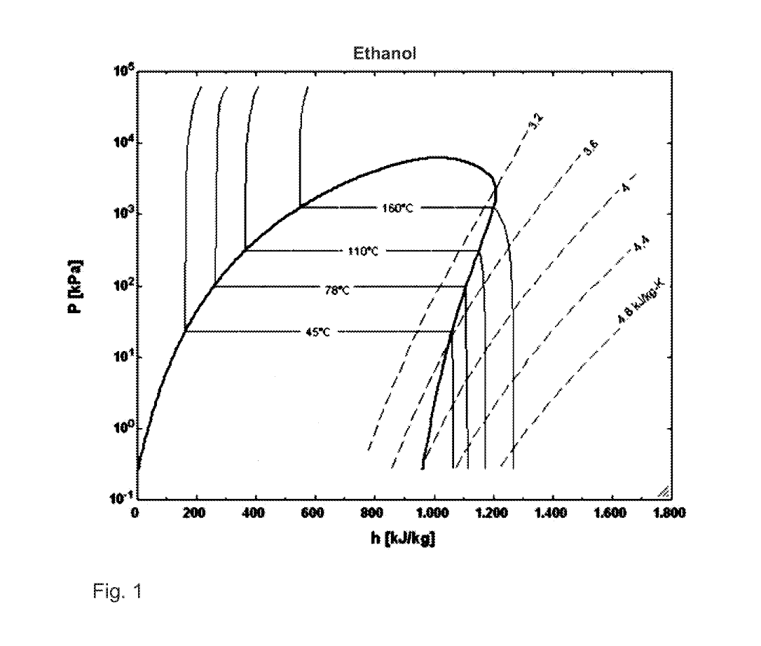

According to a preferred embodiment and as can be seen from FIG. 1, the present cold start-up system has been developed for use in Otto-cycle engines, direct injection or not, which burns gasoline, ethanol or a mixture of fuels, composed or not of a preponderant fraction of ethanol in order to ensure proper start up and running of the engine in the cold phase at low ambient temperatures, without the need of using a small auxiliary tank for gasoline injection.

It should initially be noted that the privilege of invention extends to any fuel wanted to be used, not just ethanol, and it can be used not only to enable start-up and post start-up of flex-fuel engines at low temperatures as well as to improve start-up and the post start-up of gasoline powered engines at low temperatures, or even in any other necessary or desirable use.

Moreover, even as a preliminary consideration, the system is not necessarily restricted to motor start-up at low temperature situations, because it can be used at any ambient temperature and pressure in order to optimize the amount of fuel used or even the same start-up time. Thus, the system allows the engine to start running optimally, i.e. with the smallest possible amount of fuel, depending on the fuel used, at the appropriate rotation, with the lowest possible emission of pollutants, etc.

In order to achieve its objectives, the system performs a pre-injection of fuel into the intake system (either by the injectors of the fuel injection system or by an injector or an auxiliary system) or, in the case of a direct injection engine, within at least one cylinder, before the starter motor is activated, in a synchronous manner with the rotation of the engine, or even asynchronously, which includes as a period for use of the pre-injection, the time during which the starter motor is working, but start-up is not yet characterized.

In order to better explain how the system works, let us first make some clarifications about the behavior of fuels during cold start-up of an engine.

It is well known that the coefficient of vaporization of ethanol is higher than that of gasoline, that is, it requires a higher temperature to volatilize, or vaporize, providing the chemical reaction with oxygen and its combustion. According to the graph shown in FIG. 1, the vaporization temperature of this fuel, under atmospheric pressure at sea level, is 78° C. Due to this physical property, cold start-up of an internal combustion engine fueled by ethanol is quite difficult at temperatures below 17° C.

Cold start-up is made worse by the fact that it represents a very unfavorable thermodynamic environment situation for the operation of an engine, since there is a low airflow (due to very low engine speed, which is driven by the starter motor), which generates a low volumetric efficiency (filling the cylinders with air-fuel mixture) and low turbulence.

These unfavorable conditions, when combined with the low vaporization of ethanol, especially at low temperatures, make the combustion of compressed air mixture very difficult to occur.

As an alternative to mitigate this unfavorable scenario, the engineers responsible for calibrating the supply system of the engines delay the ignition timing, that is, the moment at which the spark should be triggered by the plugs to ignite the fuel-air mixture inside the cylinders. The delay in ignition timing decreases the pumping effect and allows the engine to turn more easily in these early stages, thus facilitating start-up.

In addition, engineers handle the throttle control (the throttle opening or any other means to control the amount of admitted/aspirated air by the engine), for example, keeping the throttle closed although the user presses the accelerator pedal (possible in most modern vehicles that have electronic throttle control), which ensures a reduction of pressure within the intake manifold, which facilitates the evaporation of the fuel used (ethanol, gasoline or any mixture thereof).

However, manipulation of pressure curves and angles of ignition during start-up and the control of the position of the throttle has a limit, since they neither change, nor could change, the fuel vaporization ratio. Therefore, cold start-ups with ethanol at ambient temperature below 17° C. are still extremely difficult to obtain.

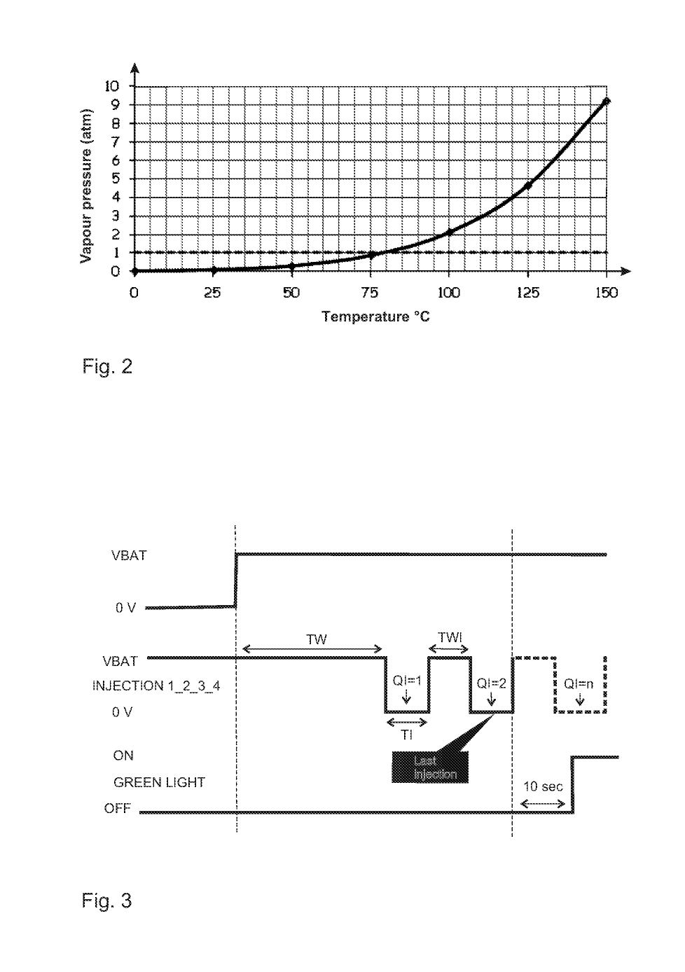

FIG. 2 shows a graph of vapor pressure of ethanol versus temperature (° C.), whose analysis allows to clearly verify the vaporizing temperature of 78° C. for 1 atm. The full line shows the vapor saturation curve of this fuel.

According to this graph, boiling of ethanol should be avoided because, once it begins to vaporize, its specific volume increases 133 times. In this case, even if the volumetric flow grows due to the fact that the fuel has become a gas and the discharge coefficient applied to this situation is much lower than if the fuel were liquid, effectively the fuel mass flow decreases. Another drawback lies in the fact that it is extremely difficult to create a mathematical model and calculate the actual amount of fuel injected when it is in vapor form.

Thus, in case the fuel boils, what will happen in practice is that an unknown and insufficient quantity of fuel will reach the cylinders, and this should be avoided.

Therefore, in case one wants to heat the ethanol prior to its injection, that is, to heat it in any part of the injection system (fuel line, fuel rail and injectors), it is necessary that this fuel is under a specific pressure value such that it does not boil and, the greater the pressure, the higher the temperature that it can be taken to so as to boil.

Tests carried out by the applicant indicate that a 600 kPa pressure (6 bar) in the fuel line allows for the cold start of an engine at low temperatures and, in practical situations, for a pressure of 420 kPa (4.2 bar), normally used in the injection system of vehicles, good results are guaranteed.

Another crucial point for cold start-up is the system calibration. Even when heated fuel is injected, as discussed in several prior art patent cases, one should bear in mind that the small amount of heated fuel inside the injectors and initially injected is not enough to, by itself, ensure start-up of the engine and its subsequent operation in the cold phase.

During researches carried out in order to enhance the study of the calibration of cold start systems, the applicant detected that, even though the heating system were efficient, the engine invariably entered into operation on the second attempt, and not on the first.

This detection made the applicant carry out further studies and researches, which culminated with the present cold start-up system, which includes pre-injection as explained above.

In essence, the development of this new technology departed from this premise and sought for the use of a calibration strategy of pre-injection of fuel, which, as mentioned above, corresponds to the fuel injection before the starter motor is activated or even during its activation, in an asynchronous manner with the motor rotation, to simulate the conditions of the first activation of the motor, that which always ended in a failure.

The pre-injection strategy simulates some conditions somewhat more advantageous for starting an engine, and that, in a normal situation would have been created at the end of the first unsuccessful attempt of starting up the engine, namely:
existence of air-fuel mixture, heated or not, in the intake manifold;
unburned fuel in the cylinders;
smaller SMD (average size of atomized fuel droplets);
existence of a film of fuel in the cylinder wall and in the intake manifold itself and valve seat;
average temperature increase inside the injectors and/or supply line (fuel rail).

The presence of heated air and fuel within the intake manifold greatly facilitates engine start up. The minimum temperature at which ethanol is ignited, at a pressure of 1 atm, is 13.5° C., therefore, cold start-up of the engine at 0° C. and −10° C. is below the minimum point of ignition. For start-up under these conditions, it is recommended to preheat the fuel, together with the pre-injection.

The smallest SMD (average size of atomized fuel droplets) is another great advantage since it provides a more homogeneous fuel-air mixture and greatly increases the total surface area of the injected fuel. Based on experiments carried out, the applicant discovered that ethanol injection, without heating, creates droplets of about microns 120-130 at a temperature of 20° C. Upon heating, the size decreases to 15-20 microns, which is translated into a 800% increase in surface area of the fuel, evidently facilitating combustion.

Regarding the existence of unburned fuel and the formation of a film inside the cylinder, it should be noted that there is always a fraction of fuel which does not enter into combustion, notwithstanding the very extreme conditions of pressure and temperature therein.

In the studies and researches carried out, the applicant has detected that the fuel located adjacent to the cylinder wall does not take part in combustion because on that surface the relationship between air and fuel is very low (less than 0.5). Nevertheless, the existence of this film is fundamental to enable the combustion process of the fuel-air mixture.

The buildup of a liquid on a surface such as a cylinder is a natural phenomenon and, once this buildup begins, the liquid spreads to create the film over the entire area of this wall.

When one wants to start up an internal combustion engine, much of the first portion of fuel (i.e. the first jet from the nozzle) will not enter into combustion, but will adhere to the cylinder wall, creating the aforementioned film, impoverishing the fuel/air mixture beyond the threshold that makes its burning possible.

Anyway, the film existing, the second start-up is enough for combustion to occur and the engine starts running.

This is the foremost reason whereby the engine started running on the second attempt: the fuel injected on the first attempt served to form the film on the cylinder wall.

And the applicant has also detected that the film formation occurs in the pipe wall of the intake manifold and in the headstock ducts (“ports”).

However, it should be noted that this film has limited durability, for it degrade at the moments of pressure transient, as for example, the effective start-up (operation) of the engine, in which case it should be formed as quickly as possible.

For this reason, the pre-injection strategy of the present cold start-up system is so important. The pre-injection prior start-up ensures the formation of the fuel film within the cylinders and, when the starter motor starts to rotate the engine, the correct air-fuel mixture ratio is achieved soon, enters into combustion and the engine starts running, while the asynchronous injection during start-up (i.e. out of sync with the rotation of the crankshaft, which is moved by the starter motor) favors the maintenance of this film.

In preferred but not limiting manner, a nozzle provided with a heating means is used which works from electrical pulses of 45-50 kHz transmitted by the electronic injection module (or any other module, dedicated or not) which, when passed through a heating coil, generate a magnetic field which turns outs to heat the adjacent fuel.

Having outlined some important information about the behavior of ethanol and the dynamics of the formation of the fuel film in the cylinder wall, now is the time to talk about the pre-injection procedure in more detail.

One first possibility of pre-injection, which can be used but it is not the preferred one, is manual. In this possibility, any button is connected to the injector and, when activated, fuel injection occurs for previous formation of the film on the cylinder wall and manifold.

Thus, the preferred embodiment of this cold start system has an automated control depending on a series of pressure and temperature parameters and motor and fuel characteristics, which will be discussed in detail later.

In any case, in the pre-injection control being automated, it can be made from various kinds of initial commands, called hereinafter ‘triggers’.

The trigger for the start of the parameterized pre-injection strategy may be automatic or manual, which includes, among others:
Opening doors and hood of the vehicle;
A timer to perform a given time count;
The nearness of the conductor carrying any identification device (like a keychain or encoded card that opens doors, widely used in higher price automobiles);
Alarm triggering (remote or not);
Activation through a unique button (remote or not);
Remote activation by cell phone or other telecommunication devices;
Activation by means of a recognition device of driver and passenger (s) (voice presence and weight);
Activation of ignition key;
Temperature detection (water, fuel, air, oil, either ambient or unique to the vehicle);
Indirect detection via relative humidity and pressure (absolute or relative);
Activation of pedals (clutch, brake, accelerator), horn, lights/lanterns, signal lights, parking brake, gear lever, or combination thereof, either in advance or during start up);
Via navigation system;
Viscosity/conductivity/permittivity sensor of water, fuel and oil (either from the motor or from the gear box) or any other fluid relevant to the vehicle; and
Use of strain gage, among others.

The privilege of the invention also covers the possibility of no specific trigger to be used, that is, actuation of the strategy in every start-up, regardless of whether the engine is cold or hot.

Moreover, it is important to note that the strategy is not restricted to the use of preheated fuel and thus it can be used for any condition of fuel temperature and pressure.

Finally, the strategy is not limited to the use of main injectors, considering the use of auxiliary injectors or similar devices located at any position of the intake system or the engine or any other fuel injection device.

Whatever the form of the pre-injection strategy activation, and in order that the present cold start system is functional and adaptive, it is preferable that such activation takes into account a number of variables such as fuel composition to be injected, outside temperature, engine temperature, and engine type, among others, and then determine how the pre-injection must be performed.

To ensure greater efficiency, the applicant has developed a series of special tests, in which one can, depending on situational parameters, manipulate (i) the time between activation of the injection module and effective pre-injection (ii) duration of pre-injection and (iii) the time between successive pre-injections in case more than one occurs, as FIG. 3.

Detailing the tests, the first procedure for its realization is the acquisition of parameters. To this end, all parameters of the electronic injection module, or similar, are monitored. In addition, some other important parameters are monitored, as can be seen in the table below.

| Sensor | Component | Property (unit) |
|---|---|---|
| 1 | Injector 1 | ° C. |
| 2 | Injector 2 | ° C. |
| 3 | Injector 3 | ° C. |
| 4 | Injector 4 | ° C. |
| 5 | Heater 1 | PWM |
| 6 | Heater 2 | PWM |
| 7 | Heater 3 | PWM |
| 8 | Heater 4 | PWM |
| 9 | HFM_MES | kg/h |
| 10 | Ethanol | % |
| 11 | Pressure in ethanol line | Bar |
| 12 | HCU | A |
| 13 | VX | V |
| 14 | V_HCU | V |

The monitoring of the above parameters enables accurate analysis of the power used by the system and how energy is effectively transferred to the fuel, in the form of heat. The monitoring of the voltage and current sent by heating module or the like (HCU) to the injectors (mentioned in the above table as sensors 12 and 14—HCU and V_HCU) monitor the current supplied to heating and the fuel temperature is monitored in each injector (sensors 1 through 4, in this case, since it is a 4-cylinder engine).

Sensors 5-8 monitor the frequency and length of electrical pulses supplied so that the injector heaters heat the fuel.

Sensor 9 is used for the subsequent calculation of the correct air-fuel ratio before ignition, used for comparisons with other values after the engine is running, as the amount of oxygen in the exhaust gas measured by the lambda probe. Thus, it is possible to calculate the correct mixture for pre-injection at the next cold start-up.

Sensor 10 can detect the percentage of ethanol in the fuel used, keeping in mind that the cold start situation is so much harder the higher the percentage of ethanol, making it more critical when its percentage exceeds 90%.

Sensor 11 monitors the pressure in the fuel line to ensure that the heated ethanol in the injection nozzles does not boil, as previously discussed.

Finally, sensor 13 checks the available charge in the battery, which is important because the cold start situation is always critical on account of the high consumption of electric current.

Moreover, it is interesting and recommended to monitor the control of electrical signals that follow the injectors. Once pre-injection strategy demands operation of the injectors before activation of the starter motor (or during its activation, in an asynchronous manner), this monitoring is the only way to control the exact duration of pre-injection, besides acting as an element of additional checking of all the cold start routine, by enabling viewing of the whole operating cycle of the injectors until the engine starts running and even after it.

The implementation of tests with variation of the several parameters mentioned above allows the cold start-up system, object of the present invention, to provide high efficiency, ensuring start-up of a flex-fuel engine even at very low ambient temperatures without the need to use gasoline.

Results:

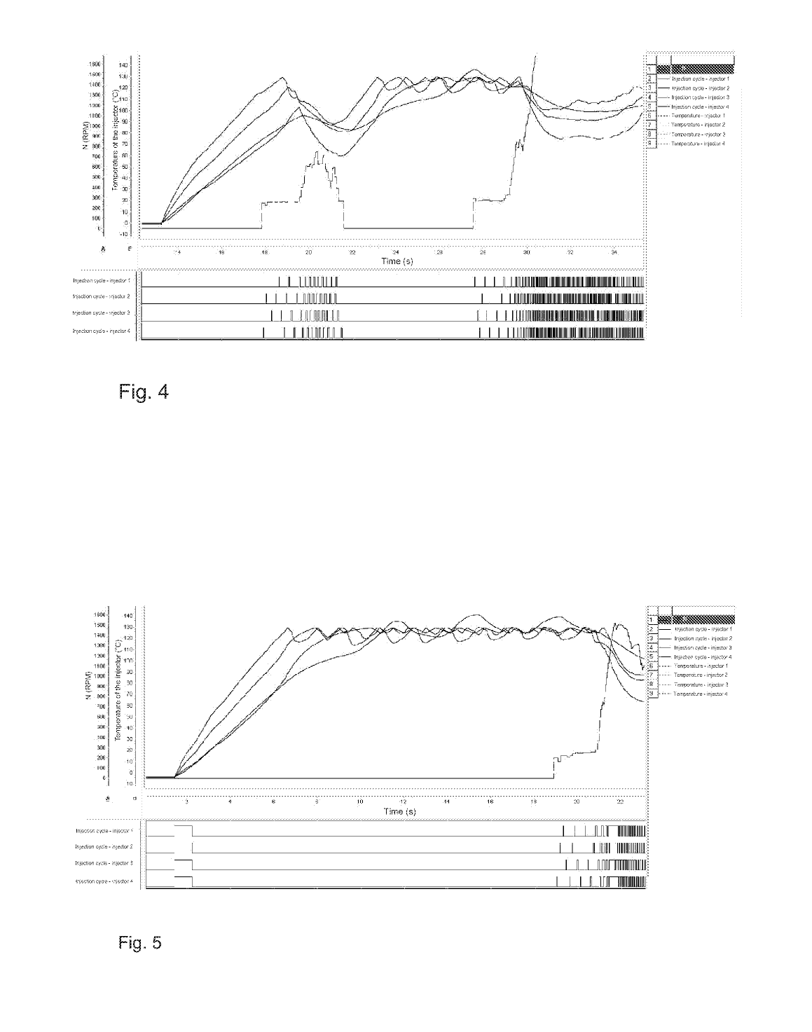

FIG. 4 shows a graph obtained after the start up of an engine driven by ethanol without the use of the pre-injection strategy at an ambient temperature of 0° C. The result is invariable: the engine does not start on the first attempt, only on the second.

Now, with the use of the pre-injection strategy, the results obtained in the tests are extremely favorable, even when the pre-fuel injection is performed with unheated fuel (which saves battery power, which will only heat the fuel, effectively intended for burning, and not the one used in forming the film on the cylinder wall).

The pre-injection of non-heated fuel is further advantageous since, due to the fact that it is not necessary to preheat it, the engine start-up can be performed moments before, successfully. Furthermore, it is guaranteed that, in no event, there will be the vaporization of fuel in the injectors, so that it becomes possible to guarantee the accurate supply of pre-injected fuel, thus optimizing start-up.

FIG. 5 shows start-up at a temperature lower than that of FIG. 4 −5.25° C. and which thanks to the pre-injection strategy was successful.

Moreover, it should be noted that a combustion engine equipped with the present cold start system is new and provided with inventive activity.

After one example of a preferred embodiment has been described, it should be understood that the scope of the present invention encompasses other possible embodiments and is limited only by the content of the appended claims, which include their possible equivalents.

1. A cold start-up system of a flex-fuel internal combustion engine, the engine comprising at least one injector nozzle to inject a fuel within at least one cylinder of the engine having a cylinder wall, the system being characterized in that fuel is pre-injected within the cylinder to form a fuel film adhered to the cylinder wall before activation of a starter motor.

2. A cold start-up system according to claim 1, characterized in that the fuel is preheated when the ambient temperature is below 13.5° C.

3. A cold start-up system according to claim 2, characterized in that the fuel is preheated at a temperature below its boiling point before being pre-injected.

4. A flex-fuel internal combustion engine cold start-up method for use with a flex-fuel internal combustion engine that can run on fuel either gasoline, ethanol or a mixture thereof, the method being characterized in that: prior to the activation of a starter motor, the fuel is pre-injected within at least one cylinder of the engine to form a fuel film adhered to a cylinder wall of the at least one cylinder.

5. A flex-fuel internal combustion engine cold start-up method according to claim 4, characterized in that the fuel is preheated when the ambient temperature is below 13.5° C.

6. A flex-fuel internal combustion engine cold start-up method according to claim 5, characterized in that the fuel is preheated at a temperature below its boiling point before being pre-injected.

7. A flex-fuel internal combustion engine cold start-up method according to claim 6, characterized in that, after the activation of the starter motor, the fuel is injected out of sync with the rotation of a crankshaft of the engine.

8. A cold start-up system of an internal combustion engine for an engine burning a fuel composed of gasoline, ethanol or a mixture thereof, composed or not of a preponderant fraction of ethanol, comprising at least one injector nozzle to inject the fuel within at least one cylinder of the engine, the system being characterized in that the fuel is pre-injected within the cylinder to ensure the formation of a fuel film adhered to a cylinder wall of the cylinder before the activation of a starter motor.

9. A cold start-up system according to claim 8, characterized in that the fuel is preheated when the ambient temperature is below 13.5° C.

10. A cold start-up system according to claim 9, characterized in that the fuel is preheated at a temperature below its boiling point before being pre-injected.

11. A cold start-up system according to claim 10, characterized in that, to preheat the fuel, the injector nozzle is provided heating which works from electrical pulses of 45-50 kHz transmitted by an electronic module which pass through a heating coil generating a magnetic field to heat the adjacent fuel.

12. A cold start-up system according to claim 1, characterized in that, after the activation of the starter motor, the fuel is injected out of sync with the rotation of a crankshaft of the engine to favor the maintenance of the fuel film adhered to the cylinder wall.

13. A cold start-up system according to claim 3, further comprising an automated control to perform the pre-injection of fuel depending on a series of pressure and temperature parameters of the engine as well as engine and fuel characteristics.

14. (canceled)
